(19) United States
(12) Patent Application Publication
(10) Pub. No.: US 2014/0371376 A1
(43) Pub. Date: Dec. 18, 2014

(54) Adhesive Paste with Increased Temperature Stability and Use Thereof for an Adhesive Tape

(71) Applicant: tesa SE, Hamburg (DE)

(72) Inventor: Thorsten Krawinkel, Hamburg (DE)

(21) Appl. No.: 14/354,458

(22) PCT Filed: Oct. 26, 2012
(86) PCT No.: PCT/EP2012/071198

§ 371 Date: Jul. 22, 2014

(30) Foreign Application Priority Data
Oct. 27, 2011 (DE) 10 2011 085 354.5

(51) Int. Cl. C09J 153/02; C09J 153/00

(52) U.S. Cl. CPC C09J 153/02; C09J 153/00; C09J 2453/00; C09J 2467/00
USPC 524/505

(57) ABSTRACT

The invention relates to an adhesive paste containing at least • a vinyl aromatic block copolymer • at least one adhesive resin • a second copolymer based on a vinyl aromatic and on an unsaturated anhydride, wherein the vinyl aromatic content is preferably at least 50 mol %.

The invention relates to a pressure-sensitive adhesive which is based on styrene block copolymers and distinguished by an enhanced temperature stability and an enhanced cohesion in tandem with high bond strength.

Pressure-sensitive adhesives (PSAs) are adhesives which even under a relatively weak applied pressure permit a durable connection with the substrate and which after service can be detached from the substrate again substantially without residue. PSAs are permanently pressure-sensitively adhesive at room temperature, thus having a sufficiently low viscosity and a high tack, meaning that they wet the surface of the respective substrate under even low applied pressure. The adhesive bonding capacity of the adhesives and their redetachability derive from their adhesive properties and from their cohesive properties. A variety of compounds are contemplated as a basis for PSAs.

Adhesive tapes furnished with PSAs, referred to as pressure-sensitive adhesive tapes, are presently in diverse use within the industrial and household spheres. Pressure-sensitive adhesive tapes consist typically of a carrier film, furnished on one or both sides with a PSA. There are also pressure-sensitive adhesive tapes which consist exclusively of a PSA layer and no carrier film, these being known as transfer tapes. The composition of the pressure-sensitive adhesive tapes may vary greatly and is dependent on the particular requirements of the various applications. The carriers typically consist of polymeric films, such as polypropylene, polyethylene or polyesters, for example, or else of paper, woven fabric or nonwoven material.

The self-adhesives or PSAs are based generally on acrylate copolymers, silicones, natural rubber, synthetic rubber, styrene block copolymers or polyurethanes.

There is a need for adhesive tapes which exhibit a very high bonding strength, but also do not lose their cohesion at elevated temperatures. In the case of adhesive bonds in the exterior sector or in motor vehicles, in particular, temperatures of more than 60° C. to 70° C. may occur. For adhesive tapes with particularly high holding performance, especially in the consumer segment, adhesives based on styrene block copolymers are frequently employed. An advantage of these adhesives is that they are able to exhibit very high bonding strength in tandem with very high cohesion. As a result of a high tack, even bonds to rough substrates are securely possible.

Typically used are linear or radial block copolymers based on polystyrene blocks and polybutadiene blocks and/or polyisoprene blocks—i.e., for example, radial styrene-butadiene (SB)ₙ and/or linear styrene-butadiene-styrene (SBS) and/or linear styrene-isoprene-styrene (SIS) block copolymers.

The products that are on the market with PSAs based on styrene block copolymers exhibit weaknesses in their bonding strength at temperatures above 50° C. Especially when being used for bonding articles of moderate weight, the softening of the hard phases consisting principally of polystyrene (block polystyrene domains) results in cohesive failure of the pressure-sensitive adhesive strips.

Bond failure occurs to a significantly greater extent in particular in the case of a tipping shear load (when a torque is active, such as in a hook bond, for example) than in the case of a pure shear load.

It is an object of the invention, therefore, to provide an improved PSA based on styrene block copolymers particularly for adhesive tapes which exhibit good bonding strength even at elevated temperature.

This object is achieved by means of a PSA as specified in the main claim. The dependent claims provide advantageous developments of the subject matter of the invention. The invention further embraces the use of this PSA.

The invention accordingly provides a pressure-sensitive adhesive and its use, consisting of a mixture at least comprising
a vinylaromatic block copolymer
at least one tackifier resin
a second copolymer, based on a vinylaromatic and an unsaturated anhydride

Described in the literature are various methods for enhancing the temperature stability of adhesives based on vinylaromatics.

Commonly used are what are called endblock reinforcers, which are compatible with the vinylaromatic endblocks but possess a higher softening point than the pure endblocks. As a result, the softening temperature is raised. Known endblock reinforcers include, primarily, aromatic C₈ and C₉ resins, described as for example in EP 1 013 733 B1, WO 00/75247 A1, EP 2 064 299 B1 or WO 08/042645 A1. Additionally employed are polyphenylene oxides and/or polyphenylene ethers, described for example in WO 00/24840 A1 or WO 03/011954 A1.

A disadvantage of these two solutions is that only a small fraction of the endblock reinforcers can be used, since oftentimes, at above just 5 wt % and certainly above 10 wt % of endblock reinforcer, there is a significant drop in the tack of the adhesive. At higher concentrations, the bond strength as well then falls.

It has surprisingly now been found that copolymers consisting of a vinylaromatic and an unsaturated anhydride provide remedy here. These polymers appear to be likewise highly compatible with the endblock, provided the vinylaromatic fraction is preferably at least 50 mol %, more preferably at least 60 mol %. In contrast to other endblock reinforcers, there is no reduction in the tack, and the bond strength as well does not go down, even if the copolymer is added at a fraction of 10 wt %.

Another advantage over the phenylene oxides is the high transparency of these polymers, allowing the adhesives generated to be transparent too.

As a result of the anhydride groups present it is possible, moreover, to crosslink the polymers. As a result of this crosslinking, the temperature stability can be raised yet further. This crosslinking may be accomplished either via a chelate compound or via a reaction with epoxides or amines. Crosslinking with epoxides functions preferably with exposure to heat, whereas the amines react spontaneously with the anhydrides even at room temperature.

PSAs employed are those based on block copolymers comprising polymer blocks formed from vinylaromatics (A blocks) such as styrene, for example, and on those formed by polymerization of 1,3-dienes (B blocks) such as butadiene and isoprene, for example, and/or on a copolymer of both. Products which have been partly or fully hydrogenated can also be employed. Block copolymers of vinylaromatics and isobutylene are likewise utilizable in accordance with the invention. Also suitable for use are block copolymers whose B blocks consist of copolymers of butadiene and/or isoprene and styrene.

Block copolymers may have linear A-B-A structure. Likewise suitable for use are block copolymers of radial architecture, and also star-shaped and linear multiblock copolymers. A-B diblock copolymers may be employed as a further component. The endblock fraction here is between 13 wt % to 40 wt %, preferably 13 wt % to 33 wt %. Mixtures of different block copolymers can also be employed, preferably mixtures of block copolymers with linear A-B-A structure and diblock copolymers, or mixtures of multiblock copolymers with radial or star-shaped architecture and diblock copolymers. Additionally preferred are mixtures of block copolymers with linear A-B-A structure, of multiblock copolymers with radial or star-shaped architecture, and of diblock copolymers.

Typical service concentrations for the block copolymers are situated in the range between 30 wt % and 70 wt %, more particularly in the range between 35 wt % and 55 wt %. Employed preferably as vinylaromatic in this case is styrene.

The polymers of vinylaromatics and unsaturated acid anhydrides are obtained preferably by radical polymerization. Given appropriate selection of the anhydrides and vinylaromatics, the individual monomers are incorporated alternately into the chain. The molar fraction of the unsaturated acid anhydrides here, according to one preferred embodiment, is at most the same as the fraction of vinylaromatics.

Examples of vinylaromatics which can be used are styrene, vinyltoluene, α-methylstyrene, chlorostyrene, o- or p-methylstyrene, 2,5-dimethylstyrene, p-methoxystyrene, and p-tert-butylstyrene.

Serving as unsaturated anhydrides are, for example, maleic anhydride, citraconic anhydride, dimethylmaleic anhydride, ethyl- and diethylmaleic anhydride, chloro- and dichloromaleic anhydride, and phenylmaleic anhydride.

Preference here is given to polymers of styrene and maleic anhydride, frequently referred to as SMA polymers. Such polymers are available commercially, for example, under the name Xiran from Polyscope Polymers, as SMA from Sartomer, and as Dylark from Nova Chemicals. These SMA polymers are available with different amounts of maleic acid and with different molecular weights. Preferred here are molecular weights which lie within the molecular weight range of the vinylaromatic endblocks in the block copolymers—that is, in the range from 8000 to 25 000 g/mol.

Possible crosslinking of these elastomers may take place in a variety of ways. On the one hand, the acid and/or acid-anhydride groups may react with crosslinkers, such as various amines or epoxy resins, for example.

Amines that may be employed here are primary and secondary amines and also amides and other nitrogen-containing compounds with a hydrogen bonded directly on the nitrogen.

Epoxy resins are typically considered to include both monomeric and oligomeric compounds having more than one epoxide group per molecule. They may be reaction products of glycidyl esters or epichlorohydrin with bisphenol A or bisphenol F or mixtures of these two. Likewise suitable for use are epoxy novolak resins obtained by reaction of epichlorohydrin with the reaction product of phenols and formaldehyde. Monomeric compounds having two or more epoxide end groups, employed as diluents for epoxy resins, can also be used. It is likewise possible to employ elastically modified epoxy resins or epoxide-modified elastomers, such as, for example, epoxidized styrene block copolymers, for example Epofriend from Daicel.

Examples of epoxy resins are Araldite™ 6010, CY-281™, ECN™ 1273, ECN™ 1280, MY 720, RD-2 from Huntsman, DER™ 331, 732, 736, DEN™ 432 from Dow Chemicals, Epon™ 812, 825, 826, 828, 830 etc. from Shell Chemicals, HPT™ 1071, 1079 likewise from Shell Chemicals, Epikote 862, 1001 etc. from Hexion.

Commercial aliphatic epoxy resins are, for example, vinylcyclohexane dioxides such as ERL-4206, 4221, 4201, 4289 or 0400 from Union Carbide Corp.

Elastified elastomers are available from CVC Thermoset Specialties under the Hypro name.

Epoxide diluents, monomeric compounds having two or more epoxide groups, are, for example, Polypox R9, R12, R15, R19, R20 etc. from UCCP.

In the case of these reactions it is usual to employ an accelerator as well. This accelerator may come from the group, for example, of the tertiary amines or modified phosphines such as triphenylphosphine, for example.

While the reaction of the amines frequently takes place even at room temperature, the crosslinking with the epoxy resins proceeds generally at elevated temperature.

A second possibility which exists is that of crosslinking via metal chelates. The crosslinking of maleic anhydride-modified block copolymers with metal chelates is known from EP 1 311 559 A1, where an increase in the cohesion of the block copolymer mixtures is described. A disadvantage of this crosslinking is the narrow restriction to hydrogenated block copolymers, since only they can be modified with maleic acid. The use of copolymers of vinylaromatics and unhydrogenated acid anhydrides has the advantage that unhydrogenated block copolymers can also be employed.

The metals of the metal chelates may be those of main groups 2, 3, 4 and 5, and the transition metals. Particularly suitable are, for example, aluminum, tin, titanium, zirconium, hafnium, vanadium, niobium, chromium, manganese, iron, cobalt, and cerium. Particularly preferred are aluminum and titanium.

Various metal chelates may be employed for chelate crosslinking, and may be represented by the following formula:

(R₁O)ₙM(XR₂Y)ₘ,
where
M is a metal as described above;
R₁ is an alkyl or aryl group such as methyl, ethyl, butyl, isopropyl or benzyl;
n is zero or a larger integer;
X and Y are oxygen or nitrogen, and may each also be bonded to R₂ through a double bond;
R₂ is an alkylene group which joins X and Y and which may be branched, or else may include oxygen or other heteroatoms in the chain;
m is an integer, but is at least 1.

Preferred chelate ligands are those resulting from the reaction of the following compounds: triethanolamine, 2,4-pentanedione, 2-ethyl-1,3-hexanediol or lactic acid. Particularly preferred crosslinkers are aluminum acetylacetonates and titanyl acetylacetonates.

A selection shall be made here of an approximately equivalent ratio between the acid and/or acid-anhydride groups and the acetylacetonate groups, in order to achieve optimum crosslinking.

However, the ratio between anhydride groups and acetylacetonate groups can be varied, in which case, for sufficient crosslinking, neither of the two groups should be present in more than a fivefold molar excess.

In a further preferred embodiment, the PSA, besides the at least one vinylaromatic block copolymer, comprises at least one tackifier resin, in order to raise the adhesion desirably. The tackifier resin ought to be compatible with the elastomer block in the block copolymers.

Suitable tackifier resins include preferably unhydrogenated, partially hydrogenated or fully hydrogenated resins based on rosin or rosin derivatives, hydrogenated polymers of dicyclopentadiene, unhydrogenated, or partially, selectively or fully hydrogenated hydrocarbon resins based on C₅, C₅/C₉ or C₉ monomer streams, or, with particular preference, polyterpene resins based on α-pinene and/or β-pinene and/or δ-limonene. Aforementioned tackifier resins may be used either alone or in a mixture. Moreover, the adhesive formulation may also include tackifier resins which are liquid at room temperature.

The adhesive may be admixed with customary adjuvants such as aging inhibitors (antioxidants, light stabilizers, etc.).

Typically employed as additives to the adhesive are the following:
plasticizing agents such as, for example, plasticizer oils or low molecular mass liquid polymers such as low molecular mass polybutenes, for example
primary antioxidants such as, for example, sterically hindered phenols
secondary antioxidants such as, for example, phosphites or thioethers
in-process stabilizers such as, for example, C radical scavengers
light stabilizers such as, for example, UV absorbers or sterically hindered amines
processing assistants
wetting additives
adhesion promoters and/or
optionally further polymers of preferably elastomeric kind; elastomers utilizable accordingly include, among others, those based on pure hydrocarbons, as for example unsaturated polydienes such as natural or synthetically generated polyisoprene or polybutadiene, elastomers with substantial chemical saturation, such as, for example, saturated ethylene-propylene copolymers, α-olefin copolymers, polyisobutylene, butyl rubber, ethylene-propylene rubber, and also chemically functionalized hydrocarbons such as, for example, halogen-containing, acrylate-containing, allyl or vinyl ether-containing polyolefins, to name but a few.

The adjuvants or additives are not mandatory; the adhesive works even without their addition individually or in any desired combination.

According to one preferred embodiment of the invention the pressure-sensitive adhesive has the following composition:
vinylaromatic block copolymer: 30 wt % to 70 wt %, more particularly 35 wt % to 55 wt %
tackifier resin or resins: 30 wt % to 70 wt %, more particularly 45 wt % to 60 wt %
a second copolymer, based on a vinylaromatic and an unsaturated anhydride: 2 wt % to 15 wt %, more particularly 5 wt % to 10 wt %

The PSAs may be produced and processed from solution, from dispersion and from the melt. Preferred production and processing procedures are accomplished from solution and also from the melt.

The adhesive of the invention can be employed with particular advantage in a single-sided or double-sided adhesive tape. This presentation allows particularly simple and uniform application of the adhesive.

The general expression “adhesive tape” here encompasses a carrier material which has been provided on one or both sides with a pressure-sensitive adhesive (PSA). The carrier material embraces all sheetlike structures, examples being two-dimensionally extended sheets or sheet sections, tapes with extended length and limited width, tape sections, diecuts, multilayer arrangements and the like. For different applications, any of a very wide variety of different carriers may be combined, such as films, fabrics, nonwovens and papers, for example, with the adhesives. Furthermore, the expression “adhesive tape” also encompasses what are called “adhesive transfer tapes”, in other words an adhesive tape without carrier. In the case of an adhesive transfer tape, the adhesive is instead applied prior to application between flexible liners which have been provided with a release coat and/or which have antiadhesive properties. For application, generally one liner is first removed, the adhesive is applied, and then the second liner is removed. In this way the adhesive can be used directly to join two surfaces.

The adhesive may be provided in fixed lengths, such as in the form of meter product, for example, or else as continuous product on rolls (archimedean spiral).

The carrier material employed in the present context for an adhesive tape is preferably polymer sheets or film composites. Such sheets/film composites may consist of all common plastics used for producing films, examples—but without restriction—including the following:

polyethylene, polypropylene—especially the oriented polypropylene (OPP) generated by monoaxial or biaxial stretching; polyvinyl chloride (PVC), polyesters—especially polyethylene terephthalate (PET) and polyethylene naphthalate (PEN), polyacrylonitrile (PAN), polycarbonate (PC), polyamide (PA), polyethersulfone (PES) or polyimide (PI). Furthermore, the sheets/film composites may in a preferred embodiment be made transparent, so that the overall construction of an adhesive article of this kind is also transparent. “Transparency” here as well denotes an average transmission in the visible range of light of at least 75%, preferably higher than 90%.

It is also possible, furthermore, to use carriers based on paper, fabric and/or nonwoven.

In the case of double-sidedly (self-)adhesive tapes, adhesives of the invention that are the same or different, and/or with the same or different layer thickness, may be employed as the top and bottom layers. The carrier in this case may have been pretreated in accordance with the prior art on one or both sides, to obtain, for example, an improvement in adhesive anchoring. It is also possible for one or both sides to have been provided with a functional layer which is able, for example, to function as a barrier layer. The PSA layers may optionally be lined with release papers or release films. Alternatively only one layer of adhesive may have been lined with a double-sidedly releasing liner.

### Production of the Pressure-Sensitive Adhesive Strips

The constituents of the PSAs were dissolved here in 3:1 toluene/acetone (solids content 40%) and coated by means of a coating bar onto a PET film with a thickness of 36 μm, to give a measurable coatweight after drying at 100° C. of 50 g/m².

### Test Methods

Unless indicated otherwise, the measurements are conducted under test conditions of 23±1° C. and 50±5% relative atmospheric humidity.

Mixtures according to the following formulas gave the bond strengths, tack values, and holding power values listed in Table 2. The bond strength, the SAFT, and the holding power were determined at 60° C. on single-sided adhesive tapes, for which the respective adhesive had been coated with a coatweight of 50 g/m² on a PET film with a thickness of 36 μm.

### Bond Strength

The bond strength is determined as follows: a steel surface is used as the defined substrate. The bondable sheetlike element under investigation is cut to a width of 20 mm and a length of approximately 25 cm, equipped with a handling section, and immediately thereafter pressed onto the substrate five times using a 4 kg steel roller with a rate of advance of 10 m/min. Immediately after that, the bondable sheetlike element is peeled from the substrate using a tensile tester (from Zwick), at an angle of 180° and a peel velocity of 300 mm/min, and the force required to accomplish this is recorded. The measurement (in N/cm) is obtained as an average value from three individual recordings.

### SAFT—Shear Adhesive Failure Temperature

This test is used for rapid testing of the shear strength of adhesive tapes under temperature loading.

For the preparation of the samples for measurement, the adhesive tape specimen is adhered to a sanded steel test plate cleaned with acetone, and then rolled over three times with a 2 kg steel roller at a speed of 10 m/min. The bond area of the sample is 13 mm×10 mm (height×width), and the sample is suspended vertically, protruding by 2 mm at the upper edge of the steel test plate, and being reinforced flush with a stable adhesive strip which serves as a support for the travel sensor.

The sample under measurement is loaded at the bottom end with a 50 g weight. Beginning at 25° C., the steel test plate with the bonded sample is heated at a rate of 9° C. per minute. Using the travel sensor, measurements are made of the slip travel of the sample as a function of temperature and time. A record is made of the temperature at which the sample has accomplished slip travel of 1000 μm.

The measurement (in ° C.) is obtained as an average value from two individual measurements.

### Static Shear Test

The shear strength is a measure of the internal strength of the adhesive and is tested in a test known as the static shear test, as follows: a 20×13 mm strip of the adhesive tape, with a single-sided coating of the adhesive with a coatweight of 50 g/m², is adhered to the test substrate (steel: material in accordance with DIN EN 10088-2, type 1, 4301, surface quality 2R, cold-rolled and bright-annealed, Rₐ 25 to 75 nm). The prepared test specimen is rolled down four times with a 2 kg weight at a velocity of 0.03 m/min and then loaded with a weight for shearing. The outcome reported is the time in minutes taken for the adhesive tape to shear off from the test substrate. The results set out in Table 2 are obtained for loading of the specimens at 5 N and at 70° C.

### Transparency

The transparency of the finished products was measured in accordance with ASTM-D 1003-61, Method A.

### Static Glass Transition Temperature T_{g}

The static glass transition temperature is determined by dynamic scanning calorimetry in accordance with DIN 53765. The figures given for the glass transition temperature T_{g} relate to the glass transformation temperature value T_{g} in accordance with DIN 53765: 1994-03, unless specifically indicated otherwise.

### Molecular Weight

The average molecular weight M_{w} is determined by means of gel permeation chromatography (GPC). The eluent used is THF with 0.1 vol % of trifluoroacetic acid. Measurement takes place at 25° C. The preliminary column used is PSS-SDV, 5 μm, 10³ Å, ID 8.0 mm×50 mm. Separation takes place using the columns PSS-SDV, 5 μm, 10³ Å, 10⁵ Å and 10⁶ Å each with ID 8.0 mm×300 mm. The sample concentration is 4 g/l and the flow rate is 1.0 ml per minute. Measurement takes place against PMMA standards.

### EXAMPLES

The invention is elucidated in more detail below by means of a number of examples, without any wish thereby to restrict the invention.

All of the examples were admixed with, as aging inhibitor, 0.5 part of Irganox 1010 and 0.5 part of Tinuvin P as UV absorber.

Composition of the examples in weight fractions—see Table 1.

TABLE 1

| | C1 | C2 | 3 | C4 | C5 | 6 | 7 | C8 | 9 | C10 | 11 |
|---|---|---|---|---|---|---|---|---|---|---|---|
| Kraton D 1161 | 45 | 42.5 | 42.5 | | | | | | | | |
| Kraton D 1102 | | | | 45 | 42.5 | 42.5 | 42.5 | 40 | 40 | | |
| Kraton G 1657 | | | | | | | | | | 45 | 42.5 |
| Escorez 1310 | 50 | 47.5 | 47.5 | 50 | 47.5 | 47.5 | 47.5 | 45 | 45 | | |
| Escorez 2203 | | | | | | | | | | | |
| Regalite R 1090 | | | | | | | | | | 45 | 42.5 |
| Shellflex 371 | 5 | 5 | 5 | 5 | 5 | 5 | 5 | 5 | 5 | 10 | 10 |
| Kristalex 1120 | | 5 | | | 5 | | | 10 | | | |
| Xiran SZ25010 | | | 5 | | | 5 | 5 | | 10 | | 5 |
| Aluminum acetylacetonate | | | 0.75 | | | 0.75 | | | 1.5 | | 0.75 |
| Diethylenetriamine | | | | | | | 0.25 | | | | |

Properties of the raw materials used:

| | |
|---|---|
| Kraton D 1161 | SIS, about 18 wt % diblock, block polystyrene content: |
| | 15 wt %, Kraton Polymers |
| Kraton D 1102 | SBS, about 17 wt % diblock, block polystyrene content: |
| | 29 wt %, Kraton Polymers |
| Kraton G 1657 | SEBS, about 29 wt % diblock, block polystyrene content: |
| | 13 wt %, Kraton Polymers |
| Escorez 1310 | Hydrocarbon resin, softening point (Ring & Ball) about |
| | 95° C., Exxon Mobil |
| Regalite R 1090 | Hydrogenated hydrocarbon resin, softening point |
| | (Ring & Ball) about 90° C., Eastman |
| Shellflex 371 | Naphthenic oil, T_{g} = −64° C., Shell |
| Kristalex 1120 | Aromatic resin based on styrene/alpha-methylstyrene, |
| | softening point (Ring & Ball) about 120° C., Eastman |
| Xyran SZ25010 | Copolymer of styrene and maleic anhydride with a |
| | MAn content of 25 wt % and a molecular weight |
| | M_{w} of 10 000 g/mol, Polyscope |
| Irganox 1010 | Sterically hindered phenol; Ciba Additive |
| Tinuvin P | UV absorber, Ciba Additive |

The Ring and Ball method is the usual method for ascertaining softening points. Details can be found in ASTM E 28 and DIN EN 1238, hereby expressly incorporated by reference.

For the exemplary pressure-sensitive adhesive strips, the following technical adhesive data were ascertained:

| | Bond strength to | | Holding power at |
|---|---|---|---|
| PSA Example No. | steel in N/cm | SAFT in ° C. | 60° C. in min |
| C1 | 10.4 | 105 | 110 |
| C2 | 9.6 | 121 | 205 |
| 3 | 10.2 | 133 | 380 |
| C4 | 13.2 | 128 | 1525 |
| C5 | 11.8 | 140 | 2140 |
| 6 | 12.9 | 148 | 3405 |
| 7 | 12.4 | 154 | 3170 |
| C8 | 9.6 | 148 | 3340 |
| 9 | 12.2 | 163 | 4215 |
| C10 | 6.3 | 97 | 65 |
| 11 | 6.6 | 121 | 1050 |

As is apparent from the examples, it is possible, by adding the styrene-maleic anhydride copolymers and crosslinking them via complex bonds or via, for example, amines, to achieve a significant increase in the temperature stability of the adhesives. At the same time, up to an amount of 5 wt %, there is hardly any perceptible reduction in bond strength. In the case of example 7, however, the amine could not be added until shortly before coating, in order to prevent premature crosslinking. In order to prevent the premature gelling in the case of the metal chelates, pentanedione was added in the examples, which preferentially forms complexes with the metal chelates and so prevents gelling.

1. A pressure-sensitive adhesive comprising a vinylaromatic block copolymer; at least one tackifier resin; and a second copolymer based on a vinylaromatic and an unsaturated anhydride, the vinylaromatic fraction being at least 50 mol %.

2. The pressure-sensitive adhesive of claim 1, wherein the vinylaromatic block copolymer is formed from polymer blocks of vinylaromatics (A blocks), and of blocks formed by polymerization of 1,3-dienes (B blocks), and/or of a copolymer of both.

3. The pressure-sensitive adhesive of claim 1, wherein the vinylaromatic block copolymer is formed from vinylaromatics and isobutylene.

4. The pressure-sensitive adhesive of claim 1, wherein the block copolymers have a linear A-B-A structure or a radial architecture.

5. The pressure-sensitive adhesive of claim 1 wherein the block copolymers are star-shaped or linear multiblock copolymers.

6. The pressure-sensitive adhesive of claim 2 wherein the block copolymers are A-B diblock copolymers, with the fraction of end blocks being between 13 wt % to 40 wt %.

7. The pressure-sensitive adhesive of claim 1 comprising mixtures of block copolymers with linear A-B-A structure and diblock copolymers, or mixtures of multiblock copolymers with radial or star-shaped architecture and diblock copolymers, or mixtures of block copolymers with linear A-B-A structure, of multiblock copolymers with radial or star-shaped architecture and of diblock copolymers.

8. The pressure-sensitive adhesive of claim 1 wherein the second copolymer vinylaromatics comprise styrene, vinyltoluene, α-methylstyrene, chlorostyrene, o- or p-methylstyrene, 2,5-dimethylstyrene, p-methoxystyrene and/or p-tert-butylstyrene.

9. The pressure-sensitive adhesive of claim 1 wherein the unsaturated anhydride in the second copolymer comprises maleic anhydride, citraconic anhydride, dimethylmaleic anhydride, ethyl- and/or diethylmaleic anhydride, chloro- and/or dichloromaleic anhydride and/or phenylmaleic anhydride.

10. The pressure-sensitive adhesive of claim 1 wherein the second copolymer consists of comprises styrene and maleic anhydride, preferably with a molecular weight of 8000 to 25 000 g/mol.

11. The pressure-sensitive adhesive of claim 1 wherein the molar fraction of the unsaturated acid anhydrides does not exceed the fraction of vinylaromatics.

12. The pressure-sensitive adhesive of claim 1 wherein the second copolymer, based on a vinylaromatic and an unsaturated anhydride, is crosslinked with amine or epoxy resin crosslinkers.

13. The pressure-sensitive adhesive of claim 1 wherein the second copolymer, based on a vinylaromatic and an unsaturated anhydride, is crosslinked via metal chelates, the metal chelate comprising a metal chelate of the following formula:
(R₁O)ₙM(XR₂Y)ₘ,
where
M is a metal from main group 2, 3, 4 or 5, or a transition metal,
R₁ is an alkyl or aryl group such as methyl, ethyl, butyl, isopropyl or benzyl,
n is zero or a larger integer,
X, Y are oxygen or nitrogen, and may each also be bonded to R₂ through a double bond;
R₂ is an alkylene group which joins X and Y and may be branched, or else may include oxygen or other heteroatoms in the chain;
m is an integer, but is at least 1.

14. The pressure-sensitive adhesive of claim 1 wherein tackifier resins are unhydrogenated, partially hydrogenated or fully hydrogenated resins based on rosin or rosin derivatives, hydrogenated polymers of dicyclopentadiene, unhydrogenated, partially hydrogenated, selectively hydrogenated or fully hydrogenated hydrocarbon resins based on C₅, C₅/C₉ or C₉ monomer streams, or, preferably, polyterpene resins based on α-pinene and/or β-pinene and/or δ-limonene.

15. The pressure-sensitive adhesive of claim 1 comprising the following composition:
30 wt % to 70 wt % of vinylaromatic block copolymer;
30 wt % to 70 wt % of tackifier resin or resins; and
2 wt % to 15 wt % of a second copolymer, based on a vinylaromatic and an unsaturated anhydride.

16. A single or double-sided adhesive tape comprising the pressure-sensitive adhesive according to claim 1.
